(19) United States
(12) Patent Application Publication
(10) Pub. No.: US 2015/0120195 A1
(43) Pub. Date: Apr. 30, 2015

(54) IDENTIFYING SUBSURFACE MATERIAL LAYER

(71) Applicant: International Business Machines Corporation, Armonk, NY (US)

(72) Inventors: Wei S. Dong, Beijing (CN); Wen Q. Huang, Beijing (CN); Chun Y. Ma, Beijing (CN); Chunhua Tian, Beijing (CN); Yu Wang, Beijing (CN); Junchi Yan, Shanghai (CN); Chao Zhang, Beijing (CN); Xin Zhang, Beijing (CN)

(21) Appl. No.: 14/527,272

(22) Filed: Oct. 29, 2014

(30) Foreign Application Priority Data
Oct. 31, 2013 (CN) 2013-10530719.1

(51) Int. Cl. G01V 99/00; G06N 99/00

(52) U.S. Cl. CPC G01V 99/00; G06N 99/005
USPC 702/11

(57) ABSTRACT

In an approach for identifying subsurface material layers, a computer processor: acquires a well log of a location to be explored, the log comprising data corresponding to multiple geophysical parameters, the data of each parameter comprising measurement values of the parameter at different depths underground; matches a reference data of each parameter corresponding to each of multiple layer transition types with the data of that parameter in the well log at depths underground, wherein each layer transition type indicates an upper material layer and a lower material layer, and the reference data is used to represent a variation trend of the parameter in a transitional zone conforming with the layer transition type; and according to the matching result, determines a layer transition type at the location to be explored and a depth of an interface between the upper material layer and the lower indicated by the layer transition type.

### CROSS-REFERENCE TO RELATED APPLICATIONS

This application claims the benefit of priority under 35 U.S.C. §119 from Application No. 201310530719.1, filed on Oct. 31, 2013 in China.

### BACKGROUND

The present invention relates to a field of strata exploration, and more specifically, to a method and apparatus for identifying a subsurface material layer in the field of strata exploration.

In order to explore subsurface oil layers, mineral layers, and other useful material layers, it is commonly necessary to analyze well logs (also referred as well sequences). A well log includes measurement data of various geophysical parameters, including SP, GR, ZDL/LDT, CNS, BHC, DLL, DIL, MSFL, CAL, etc. With measurement data of different geophysical parameters, experienced geological survey experts may manually make stratum classification and identify depth ranges of subsurface rock layers, dry layers, oil layers, water-oil layers, and water layers. However, decisions made by experienced geological survey experts empirically are sometimes inaccurate.

In addition to making manual decision empirically, stratum classification may be realized by constructing a decision tree model based on historical real values with supervised learning. Methods of stratum classification based on a decision tree model have been discussed in many documents, in which measurement data (data sequence) of different geophysical parameters in well logs is input into a learned decision tree model to determine which material layers are located at different depths. However, because the decision tree model tends to be influenced by largely distributed layers (such as rock layers) during the learning process, it is difficult for the decision tree model to accurately determine locations of less distributed layers, such as oil layers, in general, having a degree of accuracy of not above 20%. Further, because data input into the decision tree model is obtained by uniformly sampling data sequences in a well log, correlations between adjacent layers are ignored in data input into the decision tree model, making it unable to identify subsurface material layers accurately.

Further, in existing methods for identifying subsurface material layers according to well logs, generally, well logs must be collected by operators at locations to be explored at first, which are then sent to a specific department, and forecasted locations of subsurface material layers may be returned from the specific department after about one month, causing a great waste of time.

### SUMMARY

A method and apparatus for identifying subsurface material layers is provided in embodiments of this invention, which may not only represent a novel concept of identifying subsurface material layers, but also may improve the accuracy of identifying subsurface material layers.

According to one embodiment of the present invention, there is provided a method for identifying subsurface material layers, comprising: acquiring a well log of a location to be explored, the well log comprising data sequences corresponding to multiple geophysical parameters, and the data sequence of each geophysical parameter comprising measurement values of the geophysical parameter at different depths underground; matching a reference data sequence of each geophysical parameter corresponding to each of multiple layer transition types with the data sequence of that geophysical parameter in the well log at different depths underground, wherein each layer transition type indicates an upper material layer and an adjacent lower material layer, and the reference data sequence is used to represent a variation trend of the geophysical parameter in a transitional zone conforming with the layer transition type; and according to the matching result, determining a layer transition type present at the location to be explored and a depth underground of an interface between the upper material layer and the lower material layer indicated by the layer transition type.

According to another embodiment of the present invention, there is provided an apparatus for identifying subsurface material layers, comprising: an acquisition component, configured to acquire a well log of a location to be explored, the well log comprising data sequences corresponding to multiple geophysical parameters, and the data sequence of each geophysical parameter comprising measurement values of the geophysical parameter at different depths underground; a matching component, configured to match a reference data sequence of each geophysical parameter corresponding to each of multiple layer transition types with the data sequence of that geophysical parameter in the well log at different depths underground, wherein each layer transition type indicates an upper material layer and an adjacent lower material layer, and the reference data sequence is used to represent a variation trend of the geophysical parameter in a transitional zone conforming with the layer transition type; and a determination component, configured to determine, according to the matching result, a layer transition type present at the location to be explored and a depth underground of an interface between the upper material layer and the lower material layer indicated by the layer transition type.

According to the above technical solutions, with reference data sequences of geophysical parameters corresponding to layer transition types, the reference data sequences of the geophysical parameters may be matched with data sequences in the well log at different depths underground (for example, matching by computing a distance therebetween), and a certain layer transition type at a depth underground may be identified according to the matching result, and thus an interface at the depth underground between two adjacent material layers related to the layer transition type may be identified, enabling the identification of the two material layers accordingly. The above technical solution utilizes reference data sequences of geophysical parameters corresponding to layer transition types, enabling not only the real-time identification of material layers by data processing after collecting a well log at a location to be explored, but also a more accurate stratum segmentation result.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computer system which is applicable to implement the embodiments of the present invention;

FIG. 2 is a flowchart of a method for identifying subsurface material layers according to an embodiment of this invention;

FIG. 3 is an example of a measurement curve of a geophysical parameter;

FIG. 4 is a flowchart of a method for determining a reference data sequence according to an embodiment of this invention;

FIG. 5A, FIG. 5B, FIG. 5C, and FIG. 5D each show an example of determining a corresponding reference data sequence for a certain layer transition type and a certain geophysical parameter according to an embodiment of this invention;

FIG. 6 is an example of a table for storing reference data sequences according to an embodiment of this invention;

FIG. 7 is an example of a reference data sequence according to an embodiment of this invention;

FIG. 8 is a flowchart of a method for computing a distance between a reference data sequence and a data sequence in a well log according to an embodiment of this invention;

FIG. 9 is a general block diagram for realizing the method for identifying subsurface material layers according to an embodiment of this invention;

FIG. 10 is a structural block diagram of an apparatus for identifying subsurface material layers according to an embodiment of this invention; and

FIG. 11 is a structural block diagram of another apparatus for identifying subsurface material layers according to an embodiment of this invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

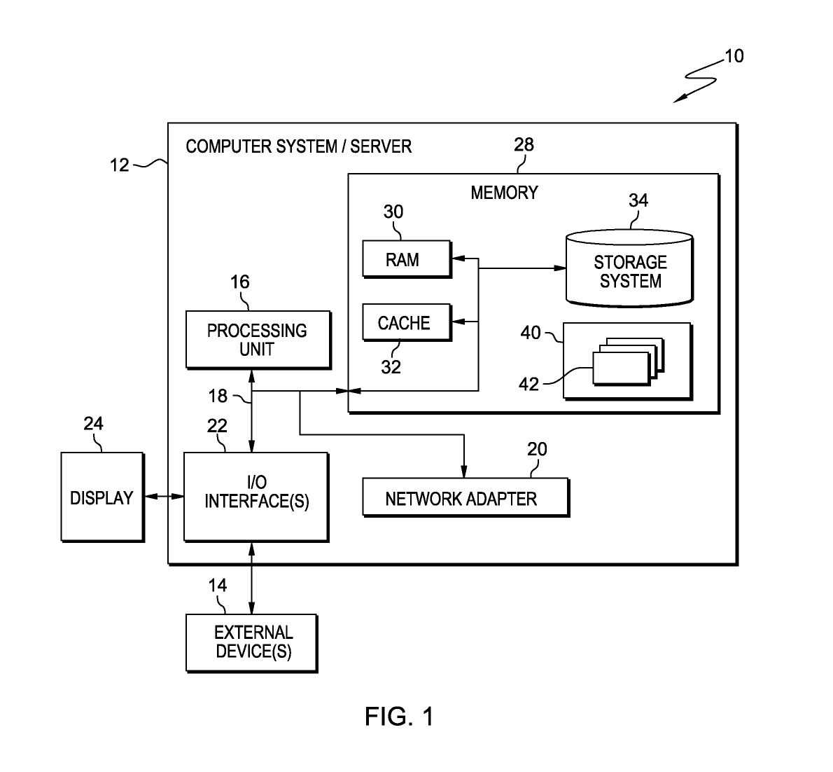

Referring now to FIG. 1, which depicts a computing environment 10, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing unit 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external device(s) 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interface(s) 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

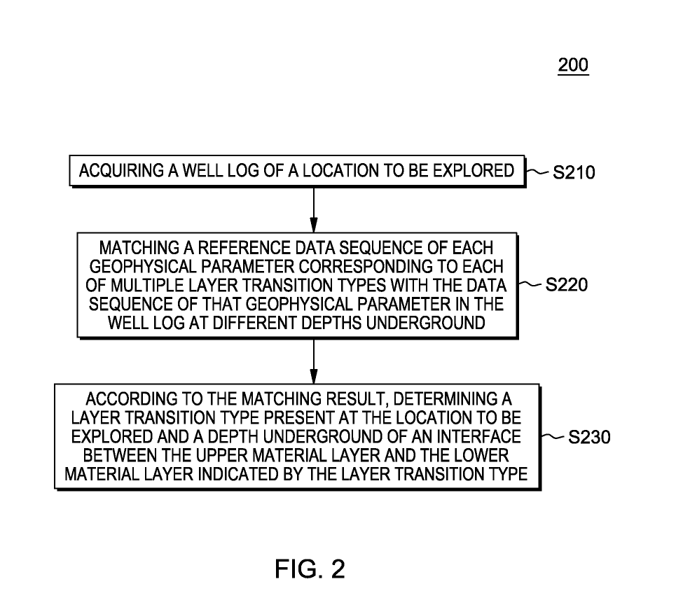

With reference now to FIG. 2, a method 200 for identifying subsurface material layers according to an embodiment of this invention will be described.

As shown in FIG. 2, the method 200 comprises: at S210, acquiring, or obtaining, a well log of a location to be explored, the well log comprising data sequences corresponding to multiple geophysical parameters, and the data sequence of each geophysical parameter comprising measurement values of the geophysical parameter at different depths underground; at S220, matching a reference data sequence of each geophysical parameter corresponding to each of multiple layer transition types with the data sequence of that geophysical parameter in the well log at different depths underground, wherein each layer transition type indicates an upper material layer and an adjacent lower material layer, and the reference data sequence is used to represent a variation trend of the geophysical parameter in a transitional zone conforming with the layer transition type; and at S230, according to the matching result, determining a layer transition type present at the location to be explored and a depth underground of an interface between the upper material layer and the lower material layer indicated by the layer transition type.

The method 200 may be executed by one or multiple computers having data processing capability. The computer may find a depth underground where a certain layer transition type is located based on the result of matching a reference data sequence of a geophysical parameter corresponding to each layer transition type with a data sequence in a well log, so as to determine adjacent upper and lower material layers at that depth. The method of partitioning subsurface material layers by finding a depth underground where a layer transition type locates may provide a completely novel concept of identifying subsurface material layers, and at the same time, because the reference data sequence which indicates the geophysical parameter correlation between upper and lower material layers is fully considered, subsurface material layers may be identified more accurately. Below, various steps of FIG. 2 will be described specifically.

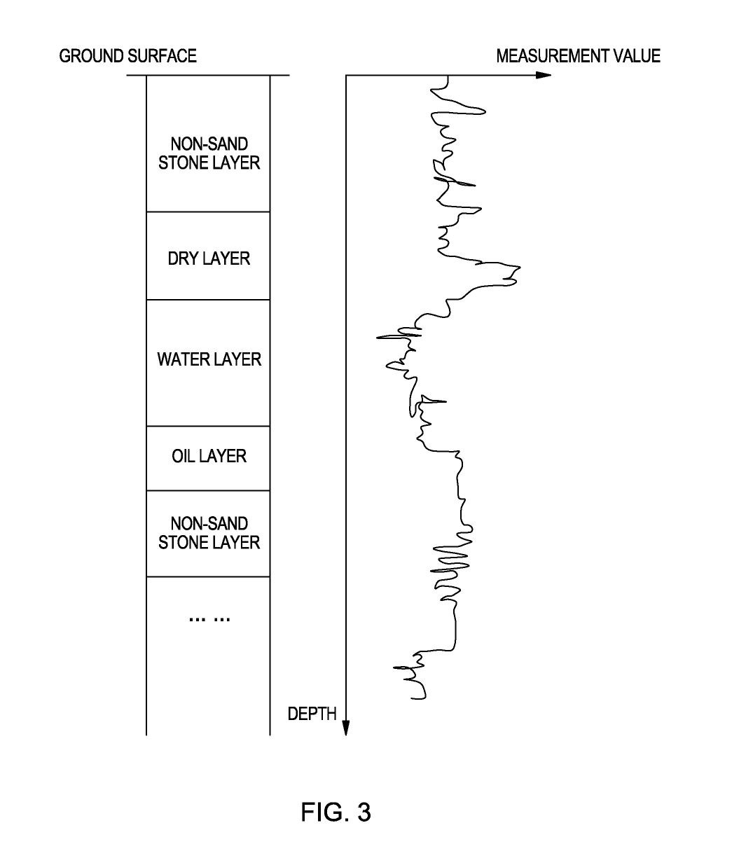

At S210, a well log may be obtained by measuring at a location to be explored in any existing method, and then a computer device having data processing capability may obtain the well log to perform a data analysis thereon. As a regular well log, the obtained well log may comprise multiple geophysical parameters (e.g., GR, SP, ZDL, etc), with each geophysical parameter having one data sequence, wherein data items contained in the data sequence are measurement values of corresponding geophysical parameter at different depths underground. For example, a curve shown in FIG. 3 (actually, a data sequence constructed by a series of discrete points) represents a measurement curve of a certain geophysical parameter (e.g., GR) corresponding to exemplary subsurface material layers shown on the left of FIG. 3, with a vertical axis representing depths and a horizontal axis representing measurement values (hereinafter, also called as data values).

At S220, adjusted reference data sequences obtained by adjusting a reference data sequence may be matched with a data sequence corresponding to the same geophysical parameter in the well log (for example, computing distances therebetween) to forecast a certain layer transition type to be located at a certain depth underground according to the match result.

Layer transition types classify possible cases of two adjacent layers, and each layer transition type indicates an upper material layer and a lower material layer. Based on a layer transition type, material layers related to a corresponding transition may be determined. For example, layer transition types may comprise non-sand stone layer→oil layer (FSYC→YC), oil layer→water layer (YC→SC), SC→YC, etc.

One reference data sequence (e.g., Shapelet) corresponds to one layer transition type and one geophysical parameter. For example, for the YC→SC layer transition type, there may be one reference data sequence for the GR parameter, and another reference data sequence for the SP parameter. The reference data sequence is used to characterize a variation trend of the geophysical parameter corresponding to the reference data sequence in a transitional zone conforming with the layer transition type corresponding to the reference data sequence. Such a variation trend may be obtained by empirical manual forecasting, or may be fitted by collecting measurement results of the geophysical parameter and corresponding actual depths in a large amount of related transitional zones. The central position of the reference data sequence corresponds to the central position of the transitional zone, and is used to indicate an interface between the upper and lower material layers.

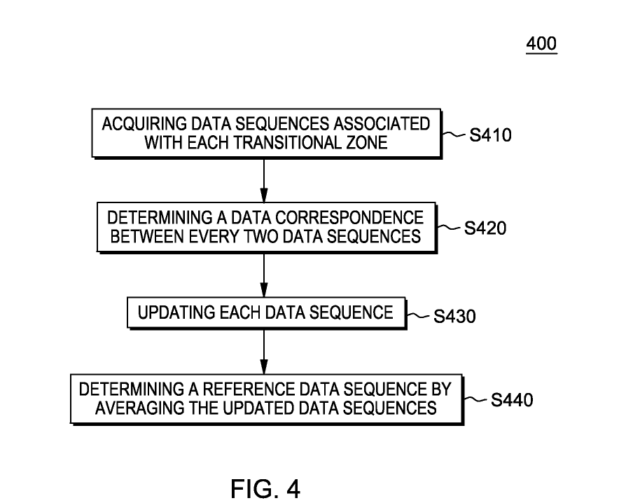

Specifically, the reference data sequence may be obtained by experienced operators or experts in advance according to actual depths and associated geophysical parameter values in transitional zones in wells that have been drilled. In the case of obtaining the reference data sequence by data fitting, the reference data sequence may be determined before S220 with a method 400 shown in FIG. 4. The method 400 is described with an example in which a reference data sequence of an arbitrary geophysical parameter (e.g., GR) corresponding to an arbitrary layer transition type (e.g., FSYC→YC) is obtained.

At S410, in multiple transitional zones having a predetermined thickness and conforming with the layer transition type, a data sequence related to each transitional zone and characterizing the geophysical parameter is acquired or obtained.

For example, data sequences characterizing GR may be obtained in multiple FSYC→YC transitional zones, for which their actual depths and associated geophysical parameter values are known (the interface between an upper material layer and a lower material layer is known, and the data sequence of the geophysical parameter remains unchanged no matter whether a well is drilled). Herein, each FSYC→YC transitional zone has a thickness of 2 m, i.e., 1 m up and down respectively from an actual interface of the transitional zone, and a data sequence of GR is obtained within such a zone. Further, the multiple FSYC→YC transitional zones may comprise FSYC→YC transitional zones at different depths in a same well, or may comprise FSYC→YC transitional zones related to different wells.

At S420, by performing alignment on each data sequence related to each transitional zone and characterizing the geophysical parameter, a data correspondence between every two data sequences is determined.

For instance, assume that a GR data sequence GR_A related to a FSYC→YC transitional zone is obtained from well A, a GR data sequence GR_B related to a FSYC→YC transitional zone is obtained from well B, a GR data sequence GR_C1 and a GR data sequence GR_C2 related to two FSYC→YC transitional zones at different depths are obtained from well C, and a reference data sequence corresponding to GR is fitted for the FSYC→YC layer transition type based on the four data sequences. Certainly, the number of transitional zones required in the fitting and the wells from where those transitional zones are originated are merely an example. In order to make the fitting of the reference data sequence more accurately, data sequences of even more transitional zones may be used. Further, because different regions (e.g., the Asian-Pacific region, the Americas, etc.) may have different geological conditions, a data sequence of a certain geophysical parameter associated with a certain layer transition type that is obtained in one region may be quite different from a data sequence of the geophysical parameter associated with the layer transition type that is obtained in another region, and thus in order to make the fitting the reference data sequence more accurate, it is possible to fit a reference data sequence for a different region separately. For a reference data sequence of a certain region, it may be fitted using data sequences collected from transitional zones in that region. For example, when different regions are concerned and those different regions have quite different geological conditions, a location to be explored may have a geographical dependence with a region corresponding to transitional zones from where the reference data sequence is fitted, i.e., the location to be explored is within or has a close distance to that region. If different regions have small differences in their geological conditions, or the reference data sequence is fitted using data from many transitional zones in different regions, it is also practical to ignore the geographical dependence.

With the above assumption, four data sequences GR_A, GR_B, GR_C1 and GR_C2 are aligned at S420. That is, all the sequences are aligned by a pair-wise alignment process. The purpose of sequence alignment is to determine a data correspondence between two data sequences and then update those sequences based on the data correspondence. For example, data items that correspond with each other in any two data sequences may be determined by the Dynamic Time Warping (DTW) algorithm. Those data items having a correspondence therebetween may be determined according to a path for calculating a distance between the two data sequences.

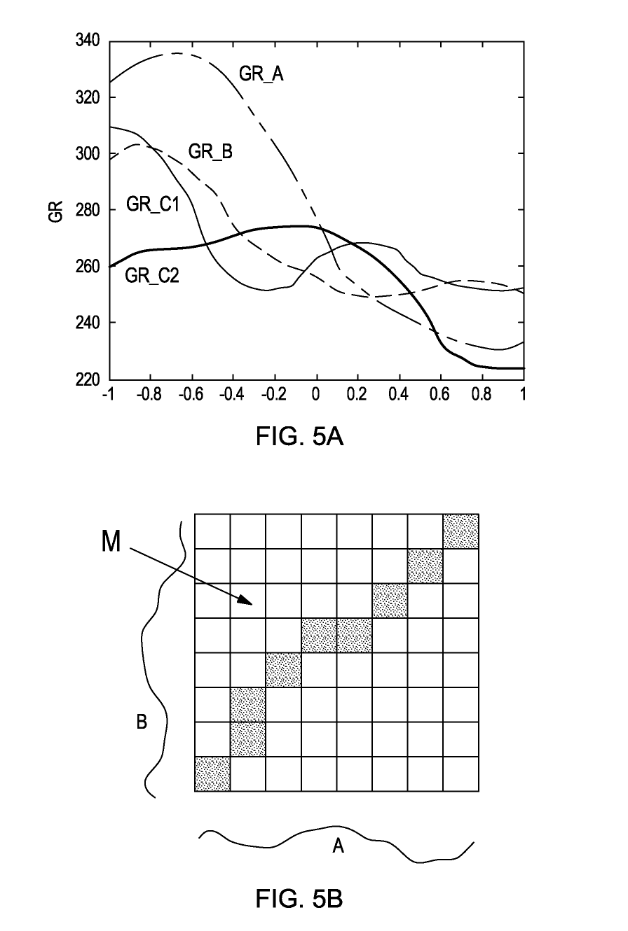

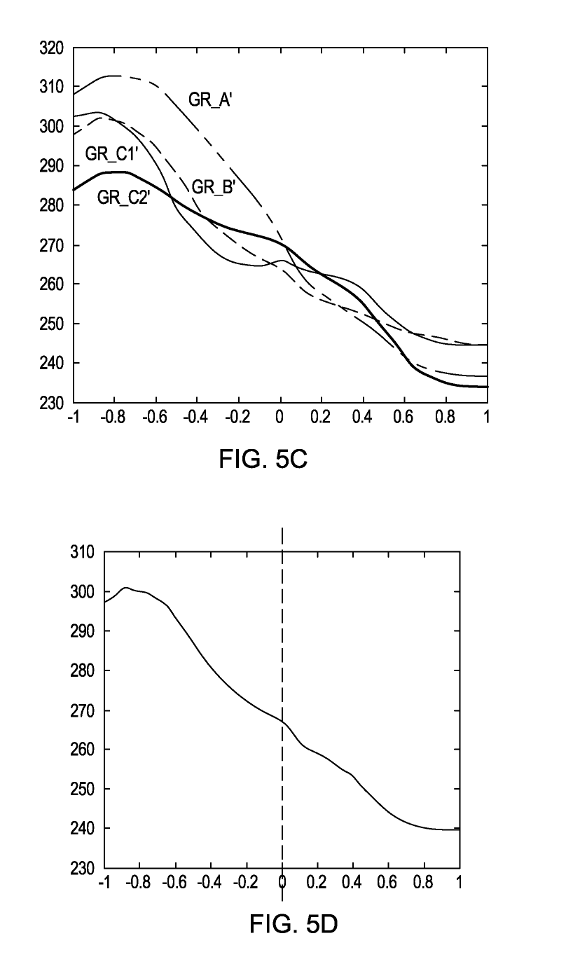

Specifically, four data sequences GR_A, GR_B, GR_C1 and GR_C2 obtained in FSYC→YC transitional zones having a thickness of 2 m are shown in FIG. 5. The horizontal axis represents relative depths in those transitional zones. The middle position of the transitional zone is set to zero, with negative relative depths set for locations in the transitional zone closer to the ground and positive relative depths set for locations in the transitional zone away from the ground. The vertical axis represents measurement values of GR.

FIG. 5B shows how to align two sequences. Herein, a description will be given with an example in which GR_A and GR_B are aligned. Any other two data sequences may be aligned in the same manner as that of GR_A and GR_B.

The existing DTW algorithm is required to align GR_A and GR_B. A distance between the two sequences may be calculated with the DTW algorithm. Further, data items that correspond to each other, namely, most similar data items in the two sequences may be found out according to a path for calculating the distance with the DTW algorithm.

Specifically, assume that each curve (data sequence) of GR_A and GR_B in FIG. 5B comprises N points, each point representing a data item in the data sequence. The N points of GR_A take up N positions sequentially on the horizontal axis from left to right, and the N points of GR_B take up N positions sequentially on the vertical axis from bottom to top. The absolute difference between the GR measurement value of a point on the horizontal axis and the GR measurement value of a point on the vertical axis is recorded in a corresponding square in an N*N matrix. For example, assume that the GR measurement value of the second position on the horizontal axis is 300, and the GR measurement value of the sixth position on the vertical axis is 320, then 20 is filled in block M in FIG. 5B. In this way, the N*N matrix may be filled up. Next, a path is searched from the left lower entry to the right upper entry of the matrix to minimize the sum of values in squares that are passed by the path. The sum of values in those squares corresponding to the path is a distance between the two sequences. Meanwhile, points that are projections on the horizontal axis and the vertical axis of each square on the path are points corresponding to each other, thereby corresponding data items in the data sequences may be determined. For example, assume that the black-filled portion is a path with the shortest distance, wherein a black square corresponds to the third point on the horizontal axis and the fourth point on the vertical axis, i.e., the third data item of GR_A has a correspondence to the fourth data item of GR_B. Based on the path having the shortest distance, for each point in GR_A, its corresponding point or points in GR_B may be found out. A point in GR_A may correspond to a point in GR_B (for example, in FIG. 5B, the fourth data item of GR_A corresponds to the fifth data item of GR_B), or may correspond to multiple points in GR_B (for example, in FIG. 5B, the second data item of GR_A corresponds to the second and third data items of GR_B). When the correspondence between two data sequences is determined, it means that the two data sequences are aligned with each other.

At S430, for each of all the data sequences related to the multiple transitional zones, according to the data correspondence between each data sequence except for that data sequence among all the data sequences and that data sequence, that data sequence is updated using the other data sequences.

For example, as to the GR_A data sequence, it is updated according to each data sequence of GR_B, GR_C1, and GR_C2. Specifically, when GR_A is updated using GR_B, assume that the first data item A1 of GR_A corresponds to the first data item B1 of GR_B, the second data item A2 of GR_A corresponds to the second data item B2 to the fourth data item B4 of GR_B, and the third data item A3 of GR_A corresponds to the fifth data item B5 and the sixth data item B6 of GR_B. Then, the first data item A1 of GR_A is substituted by (A1+B1)/2 as the first data item of updated GR_A; the second data item A2 of GR_A is substituted by (A2+B2+B3+B4)/4 as the second data item of updated GR_A; and the third data item A3 of GR_A is substituted by (A3+B5+B6)/3 as the third data item of updated GR_A. in this way, GR_A may be updated using GR_B according to the correspondence between GR_B and GR_A. Similarly, GR_A may be updated using GR_C 1 and GR_C2 respectively. Thus, using the data sequence to be updated GR_A as a basis, three updated data sequences of GR_A are obtained by updating GR_A using GR_B, GR_C1 and GR_C2, respectively.

In addition to updating GR_A, it is required to update each of other data sequences related to the transitional zones in the same way as described above.

At S440, the updated data sequences are averaged to determine a reference data sequence of the geophysical parameter corresponding to the layer transition type.

Specifically, updated versions of data sequences related to the various transitional zones may be obtained at S430, which are then averaged to determine a reference data sequence of the corresponding geophysical parameter.

For example, for all the data sequences that are obtained by updating GR_A, GR_B, GR_C1, and GR_C2 at S430, an arithmetical mean of their values on the vertical axis is taken at the same horizontal position to obtain an averaged curve, which is a GR reference data sequence.

For each of GR_A, GR_B, GR_C1, and GR_C2, FIG. 5C shows an averaged data sequence for each of them that is obtained by updating with other data sequences. For example, GR_A′ is a curve obtained by taking the arithmetical mean of three data sequences that are obtained by updating GR_A with GR_B, GR_C1, and GR_C2 respectively. FIG. 5D show a GR reference data sequence obtained by taking the arithmetical mean of the four curves in FIG. 5C. In addition to obtaining a reference data sequence by progressive updating as shown in FIG. 5C and FIG. 5D, a reference data sequence may be obtained by directly taking the arithmetical mean of all the updated data sequences obtained at S430. Besides, it may occur to those skilled in the art that, in addition to taking the arithmetical mean, because the various curves may have different degrees of importance, each curve may be provided with a different weight for a weighted averaging process.

By averaging updated data sequences, in addition to obtaining a reference data sequence of a geophysical parameter (e.g., GR) corresponding to a layer transition type (e.g., FSYC→YC) as shown in FIG. 5D (an approximate trend or a statistical variation condition of the parameter in the transitional zones), a value at the middle position of the reference data sequence may be determined. An average value of points of all the updated data sequences at their middle position are calculated according to the averaging method described above as a value at the middle position. As described below, because it is required for an adjusted reference data sequence of the reference data sequence to keep the value at its middle position unchanged, the value of the reference data sequence at its middle position, after being determined, remains unchanged in a later matching process.

The method 400 of obtaining a reference data sequence may effectively handle shifts, compression, stretching, noise and so on present in the data sequences related to the transitional zones that are obtained at S410, enabling the reference data sequence to reflect a variation trend (a general trend) of a corresponding geophysical parameter in the transitional zones more accurately.

With the example described according to FIGS. 4 and 5, a GR reference data sequence may be obtained for the FSYC→YC layer transition type. In a similar way, a reference data sequence of another geophysical parameter may be obtained for the FSYC→YC layer transition type, and reference data sequences of a geophysical parameter may be obtained for other layer transition types as well.

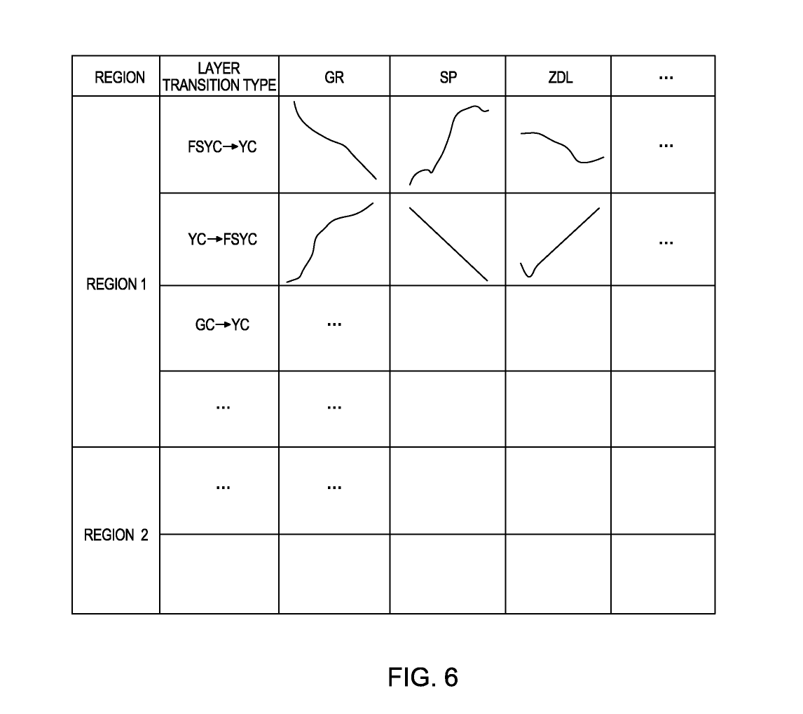

Reference data sequences obtained by learning as shown in FIG. 4 may be stored in a database for later use. FIG. 6 shows an example of a table having reference data sequences stored therein, which may be saved in a database. It can be seen from the table of FIG. 6, for each layer transition type, reference data sequences of multiple geophysical parameters may be saved respectively. In addition, different regions may be distinguished to, with respect to each different region, save reference data sequences of multiple geophysical parameters for each layer transition type. When the saved reference data sequences are distinguished based on regions, it is required to select reference data sequences of a region which the location to be explored belongs to or is closest to based on a geographical dependence for the matching performed at S220.

Continuing with S220, in the matching process, adjusted reference data sequences are needed, which are obtained by adjusting a reference data sequence according to the number of data items contained in the reference data sequence and the magnitude of those data items. According to an embodiment of this invention, the adjusted reference data sequences obtained by adjusting a reference data sequence are obtained by changing the number of data items contained in the reference data sequence and the difference between the maximum data and the minimum data of the reference data sequence, while keeping a data at the middle of the reference data sequence unchanged.

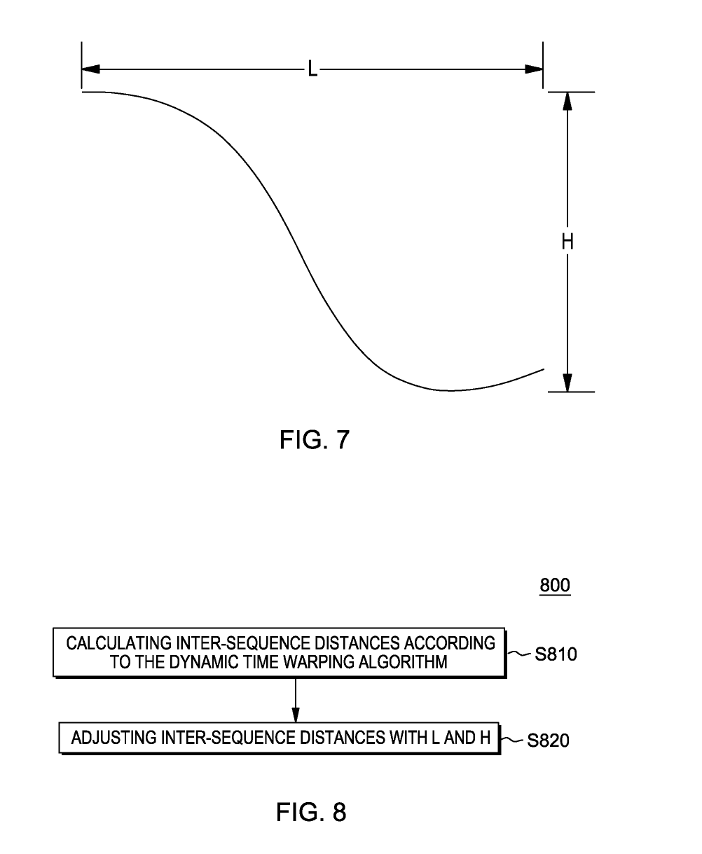

For example, an example of a reference data sequence is shown in FIG. 7. Assume that a reference data sequence S saved in the table of FIG. 6 is in a shape shown in FIG. 7. The reference data sequence S may be changed by two variables to obtain an adjusted reference data sequence. One variable is the number L of data items contained in the reference data sequence S. The larger L is, the more positions that are related in the reference data sequence S in the depth direction are. The other variable is the difference H between the maximum data and the minimum data of the reference data sequence S. Because a reference value at the middle position of the reference data sequence S has been known, the value of each data item in the reference data sequence S may be determined based on H. Each adjusted reference data sequence of the reference data sequence S is symmetric with respect to the middle position of the reference data sequence S, and each adjusted reference data sequence has the same data value at its middle position. Thus, by changing L and H of the reference data sequence S while keeping the data at the middle position unchanged, multiple adjusted reference data sequences of the reference data sequence S may be obtained. Note that adjusting reference data sequence S also comprises a situation in which L and H are kept unchanged, and thus the reference data sequence S itself may belong to its adjusted reference data sequences.

According to an embodiment of this invention, S220 may be implemented as follows: for each of multiple geophysical parameters, calculating distances at different depths underground between adjusted reference data sequences and the data sequence of the geophysical parameter in the well log, wherein the adjusted reference data sequences are obtained by adjusting the number of data items and the magnitude of those data items contained in the reference data sequence of the geophysical parameter corresponding to each layer transition type; and for each of multiple layer transition types, summing the distances at the same depth calculated for the geophysical parameters of the layer transition type.

In the above distance calculation step, for a certain reference data sequence and a data sequence corresponding to the same geophysical parameter as the reference data sequence, their distances at different depths underground may be calculated according to the method 800 shown in FIG. 8.

At S810, for each adjusted reference data sequence obtained by adjusting the reference data sequence, inter-sequence distances at different depths underground between the adjusted reference data sequence and the data sequence of the geophysical parameter are calculated with the DTW algorithm.

For example, assume that there are two adjusted reference data sequences S1 and S2 of the GR reference data sequence S corresponding to the FSYC→YC layer transition type. For the adjusted reference data sequence S1, it is moved sequentially on the GR data sequence, and a distance between the adjusted reference data sequence S1 and a data portion that overlaps with S1 is calculated with the DTW algorithm (the distance calculated with the DTW algorithm is also called as an inter-sequence distance). Each calculated distance is the distance at a depth where the GR data overlapped with the middle position of the adjusted reference data sequence S1 is located. Thus, inter-sequence distances between the adjusted reference data sequence S1 and the GR data sequence at different depths underground can be calculated. Similarly, for the adjusted reference data sequence S2, by moving it on the GR data sequence sequentially and calculating inter-sequence distances with the DTW algorithm, inter-sequence distances between the adjusted reference data sequence S2 and the GR data sequence at different depths underground may be calculated as well.

In addition to the GR reference data sequence, reference data sequences of other geophysical parameters may be also provided for the FSYC→YC layer transition type. For each adjusted reference data sequence of each of these reference data sequences, inter-sequence distances to a data sequence of a corresponding geophysical parameter may be calculated in the similar manner described above. Further, in addition to the FSYC→YC layer transition type, there may be other layer transition types. For each of these layer transition types, for each adjusted reference data sequence of each reference data sequence, inter-sequence distances to a data sequence of a corresponding geophysical parameter may be calculated in the similar manner described above.

At S820, results obtained by adjusting the inter-sequence distances according to the number of data items, L, and the difference between the maximum data and the minimum data, H, corresponding to the adjusted reference data sequence are determined as distances at different depths underground between the adjusted reference data sequence and the data sequence of the geophysical parameter.

Specifically, for each inter-sequence distance D, it needs to be adjusted (e.g. weighted) using L and H corresponding to an adjusted reference data sequence from which the inter-sequence distance is obtained, and the result of the adjustment is used as a distance at a corresponding depth underground between the adjusted reference data sequence and the data sequence of a corresponding geophysical parameter. For example, the result of (D/L)/H is used as the distance between the adjusted reference data sequence and the data sequence. By performing adjustment with L and H, incomparable inter-sequence distances caused by different reference data sequences with different lengths and values may be avoided.

Further, the reference data sequence and the data sequence are both constructed by discrete points. The depth interval between adjacent discrete points may be 1/16 m as used when the well log is generated. The time required for traversal distance calculation of so many data items may be increased and more resources may be consumed. Thus, according to an embodiment of this invention, multiple-level sampling may be performed on the reference data sequence and the data sequence to reduce the data amount for each of those sequences, while ensuring the depth corresponding to adjacent points of the reference data sequence is the same as that corresponding to adjacent points of the data sequence. Any existing multiple-level sampling techniques may be used to perform the multiple-level sampling. For example, an average may be taken for every ten data values to reduce the amount of data.

In the case of performing multiple-level sampling on the reference data sequence and the data sequence, an adjusted reference data sequence of the reference data sequence subjected to the multiple-level sampling can be matched with the data sequence subjected to the multiple-level sampling, for example, to calculate distances therebetween at different depths underground. Thereby, the amount of computation may be reduced in the matching process, with a shortened computing time and improved processing efficiency.

In the above step of summing the distances, for each layer transition type, at a specific depth underground, distances obtained using various reference data sequences of this type may be added as a summed distance at that depth for this layer transition type. There may be multiple summed distances corresponding to one depth for one layer transition type, because each reference data sequence may have multiple adjusted reference data sequences. For example, assume that there are a GR reference data sequence S1 and a SP reference data sequence S2 for the FSYC→YC layer transition type, each of S1 and S2 having 2 adjusted reference data sequences respectively. At any depth underground, the FSYC→YC layer transition type corresponds to the following four summed distances: the sum of a distance at that depth which is obtained using a first adjusted reference data sequence of S1 and a GR data sequence and a distance at that depth which is obtained using a first adjusted reference data sequence of S2 and a SP data sequence; the sum of a distance at that depth which is obtained using a second adjusted reference data sequence of S1 and the GR data sequence and a distance at that depth which is obtained using a first adjusted reference data sequence of S2 and the SP data sequence; the sum of a distance at that depth which is obtained using the first adjusted reference data sequence of S1 and the GR data sequence and a distance at that depth which is obtained using the second adjusted reference data sequence of S2 and the SP data sequence; and the sum of a distance at that depth which is obtained using the second adjusted reference data sequence of S1 and the GR data sequence and a distance at that depth which is obtained using the second adjusted reference data sequence of S2 and the SP data sequence.

In the above method, summed distances at different depths may be obtained for all layer transition types as a matching result that is obtained at S220. These summed distances may be used to reflect matching degrees between adjusted reference data sequences of reference data sequences and data sequences.

Returning to FIG. 2, at S230, according to the matching result, a layer transition type and a depth underground when reference data sequences most closely match with data sequences in the well log are determined as a layer transition type at the location to be explored and a depth underground of the interface between an upper material layer and a lower material layer that are indicated by the layer transition type, respectively. Herein, when reference data sequences most closely match with data sequences in the well log, it may represent that adjusted reference data sequences of respective reference data sequences of multiple geophysical parameters under a certain layer transition type are most similar to a portion of a corresponding data sequence at a certain depth underground in a whole. Most closely matching may mean not only the highest similarity degree, but also similarity degrees in a certain range. That is, when the matching degree between reference data sequences and data sequences in the well log meets a predetermined condition (for example, a smallest matching result or a matching result less than a predetermined threshold), it may be considered that reference data sequences most closely match with data sequences in the well log.

Specifically, for example, based on a minimum value of the summed distances obtained for multiple layer transition types above, a depth underground where an upper layer and a lower layer indicated by a layer transition type corresponding to the minimum value located is determined. In other words, a minimum value of those summed distances is determined, based on which a corresponding layer transition type and a depth underground may be identified, and thereby an interface at that depth between an upper geological layer and a lower geological layer related to the corresponding layer transition type, and in turn both the geological layers, may be determined.

The problem described above for identifying a depth with the smallest summed distance belongs to an optimization problem, which may be solved by an optimization method, for example, a genetic algorithm.

In the optimization problem, it is required to find a k which is relevant to the depth underground, to minimize a following objective function f(k,L,H) that needs to be evaluated for all the layer transition types:

$$f ( k , L , H ) = {\sum }_{i = 1}^{FS} \vert {Sha}_{( i ) , L , H} , {LS}_{( i ) , k , L} \vert$$

Wherein, k is a sequence number of a point contained in the data sequence, a depth corresponding to a point having a sequence number k may be determined based on k and a depth interval between adjacent points of the data sequence; L is the number of data items contained in the reference data sequence, i.e., the length of the reference data sequence in the depth direction; H is the length of the reference data sequence in the magnitude (amplitude) direction; FS is the number of geophysical parameters to be considered, wherein geological layers may be identified with not less than five geophysical parameters; Shα_{(t)L,H} is an adjusted reference data sequence obtained by adjusting the ith reference data sequence according to L and H; LS_{(t),k,L} is a portion of the ith data sequence centered at k and with a span of L, herein, the ith reference data sequence and the ith data sequence correspond to a same geophysical parameter; |·| is an operator for calculating the Euclidean distance between two sequences with different lengths.

By finding a depth underground and a layer transition type corresponding to a k that minimizes the objective function f(k,L,H), correlated subsurface material layers may be identified.

For another example, according to multiple values less than a predetermined threshold among the summed distances obtained for multiple layer transition types as described above, for each of the multiple values, it may be determined that an upper layer and a lower layer indicated by a layer transition type corresponding to the value located at a depth underground corresponding to that value. Herein, the predetermined threshold may be determined empirically. By using multiple values less than a predetermined threshold among the summed distances, depths where layer transition types corresponding to those values occur may be determined, and thus more subsurface material layers can be identified at the same time. Further, with the determined two adjacent depths underground and associated layer transition type, it may be determined that a certain subsurface material layer locates between the two depths underground, and thus a range of the subsurface material layer may be identified.

When a range of a certain subsurface material layer may be determined, whether the identification of the subsurface material layer is correct may be determined based on an existing decision tree model. Specifically, a measurement value at the middle position of a material layer between two adjacent depths underground may be input into the decision tree model, and it is determined whether the output of the decision tree model indicates that the measurement value corresponds to the material layer. If the output of the decision tree model indicates that the measurement value corresponds to the material layer, the identification of the material layer is correct. Otherwise, an expert in a related field may be prompted to further determine whether the material layer is identified correctly. If the identification of the material layer is not correct, reference data sequences associated with a layer transition type indicating that subsurface material layer may be deleted.

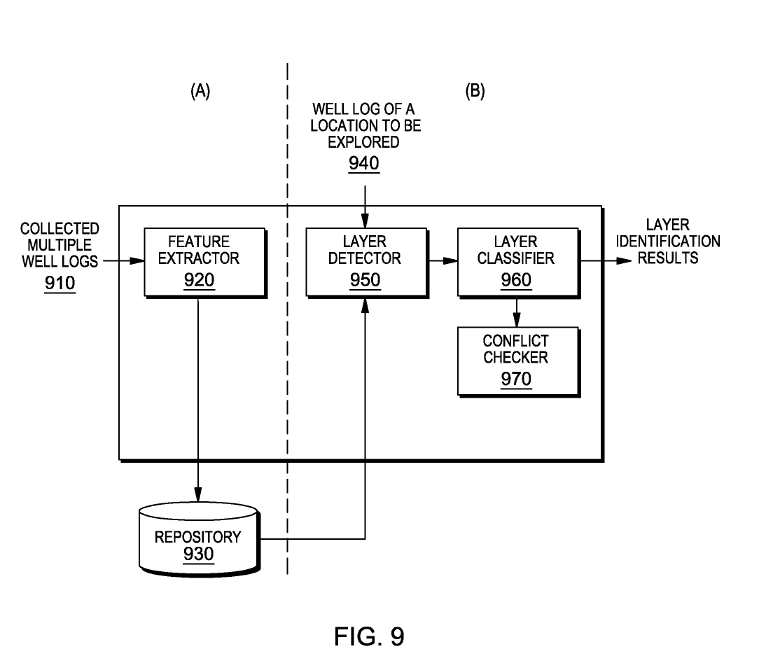

FIG. 9 shows a general block diagram for realizing the method of identifying subsurface material layers according to an embodiment of this invention. The (A) portion of FIG. 9 shows a process of constructing the table of FIG. 6, and the (B) portion of FIG. 9 shows a process of identifying subsurface material layers at a location to be explored.

Multiple well logs 910 that are collected in a region related to a location to be explored and whose corresponding wells have known data are input into a feature extractor 920. The feature extractor 920 obtains reference data sequences of geophysical parameters corresponding to different layer transition types according to the method described with reference to FIG. 4 and FIG. 5, and then stores them in a repository 930 in the form shown in FIG. 6.

When it is required to identify subsurface material layers at the location to be explored, a well log 940 of the location to be explored is input into a layer detector 950. The layer detector 950 uses reference data sequences stored in the repository 930 to identify subsurface material layers based on the method described with reference to FIGS. 2 and 8. According to the identification result of the layer detector 950, measurement values of geophysical parameters at the middle position of an identified material layer are input into a layer classifier 960 (for example, a decision tree model), to determine whether a material layer classified by the layer classifier 960 according to the input measurement values is consistent to the identification result of the layer detector 950. If consistent, the identification result of the layer detector 950 is correct and then is output; otherwise, a conflict checker 970 is triggered to prompt a user the inconsistency, enabling the user to make a further decision about subsurface material layers according to the well log 940.

According to the novel method for identifying subsurface material layers provided in an embodiment of this invention, with reference data sequences that are determined based on a full consideration of variations of different geophysical parameters in a transitional zone of adjacent material layers, subsurface material layers may be identified more accurately. According to experiments of the inventors, the identification accuracy degree of useful material layers such as oil layers may arise from about 20% to about 90%, and the identification accuracy degree of all subsurface material layers may arise from about 80% to about 97%. Further, data processing and analyzing on the well log and reference data sequences enable real-time identification of material layers according to the well log, and thus efficiency may be improved, and latency caused by sending the well log to specific department or experts for identifying material layers may be avoided. Further, because multi-level sampling may be performed on the well log and the reference data sequences before their data processing and analyzing, the amount of data processing may be reduced, and thus data processing time and system cost may be reduced.

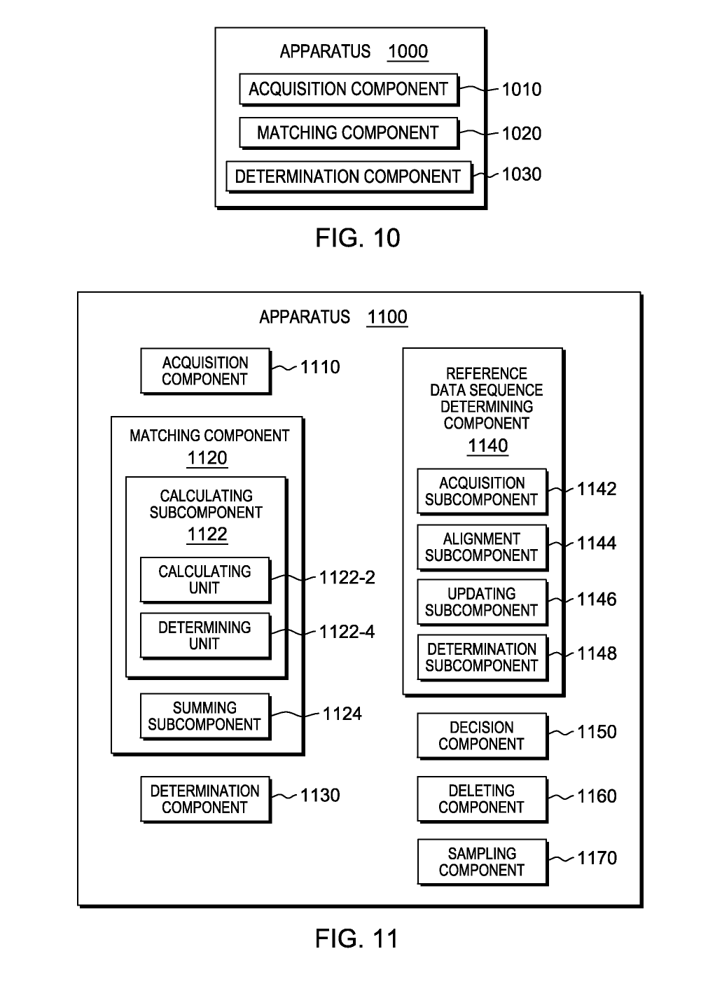

A method for identifying subsurface material layers according to an embodiment of this invention has been described above. Below, a structural block diagram of an apparatus for identifying subsurface material layers according to an embodiment of this invention will be described with reference to FIGS. 10 and 11.

An apparatus 1000 for identifying subsurface material layers according to an embodiment of this invention shown in FIG. 10 comprises an acquisition component 1010, a matching component 1020 and a determination component 1030. These components may be realized by a processing unit, such as a CPU, or may be realized by circuit modules implementing corresponding functions, or a combination thereof. The apparatus 1000 may be a portion of a computer device or may be implemented by multiple computer devices over a network.

The acquisition component 1010 may be configured to acquire a well log of a location to be explored, the well log comprising data sequences corresponding to multiple geophysical parameters, and the data sequence of each geophysical parameter comprising measurement values of the geophysical parameter at different depths underground. The matching component 1020 may be configured to match a reference data sequence of each geophysical parameter corresponding to each of multiple layer transition types with the data sequence of that geophysical parameter in the well log at different depths underground, wherein each layer transition type indicates an upper material layer and an adjacent lower material layer, and the reference data sequence is used to represent a variation trend of the geophysical parameter in a transitional zone conforming with the layer transition type. The determination component 1030 may be configured to determine, according to the matching result, a layer transition type present at the location to be explored and a depth underground of an interface between the upper material layer and the lower material layer indicated by the layer transition type.

Reference can be made to the description given with reference to FIGS. 2 to 9 for the above and other operations and/or functions of the acquisition component 1010, the matching component 1020 and the determination component 1030, which will not be repeated to avoid repetitions. Using reference data sequences of geophysical parameters corresponding to a layer transition type, the apparatus 1000 may identify subsurface material layers more accurately.

An acquisition component 1110, a matching component 1120 and a determination component 1130 comprised in the apparatus 1100 for identifying subsurface material layers shown in FIG. 11 are substantially the same as the acquisition component 1010, the matching component 1020 and the determination component 1030 comprised in the apparatus 1000 shown in FIG. 10, respectively.

According to an embodiment of this invention, the determination component 1030 may be configured to, according to the matching result, determine a layer transition type and a depth underground in a case that reference data sequences most closely match data sequences as a layer transition type at the location to be explored and a depth underground of the interface between an upper material layer and a lower material layer that are indicated by the layer transition type, respectively.

According to the embodiment of this invention, the matching component 1120 may comprise a calculating subcomponent 1122 and a summing subcomponent 1124. The calculating subcomponent 1122 may be configured to calculate, for each of the multiple geophysical parameters, distances at different depths underground between adjusted reference data sequences and the data sequence of the geophysical parameter in the well log, wherein the adjusted reference data sequences are obtained by adjusting the number of data items included in the reference data sequence and the data amplitude of the reference data sequence of the geophysical parameter corresponding to each layer transition type. The summing subcomponent 1124 may be configured to sum, for each of the multiple layer transition types, distances at same depths underground calculated for geophysical parameters associated with the layer transition type. In this case, the determination component 1130 may be specifically configured to determine, according to the minimum value of the summed distances obtained for the multiple layer transition types, a layer transition type and a depth underground corresponding to the minimum value as a layer transition type present at the location to be explored and a depth underground of an interface between an upper material layer and a lower material layer indicated by the layer transition type, respectively, or, the determination component 1130 may be specifically configured to according to multiple values less than a predetermined threshold of the summed distances obtained for the multiple layer transition types, determine, for each of the multiple values, a layer transition type and a depth underground corresponding to that value as a layer transition type present at the location to be explored and a depth underground of an interface between an upper material layer and a lower material layer indicated by the layer transition type.

According to an embodiment of this invention, the apparatus 1100 may further comprise a reference data sequence determining component 1140. The reference data sequence determining component 1140 may be configured to predetermine, based on multiple transitional zones having a predetermined thickness conforming with each layer transition type, the reference data sequence of each geophysical parameter corresponding to the layer transition type by an acquisition subcomponent 1142, an alignment subcomponent 1144, an updating subcomponent 1146, and a determination subcomponent 1148. The acquisition subcomponent 1142 may be configured to acquire data sequences characterizing the geophysical parameter associated with each transitional zone. The alignment subcomponent 1144 may be configured to, by aligning the data sequences characterizing the geophysical parameter associated with each transitional zone, determine a data correspondence between every two data sequences. The updating subcomponent 1146 may be configured to, for each of all the data sequences associated with the multiple transitional zones, according to a correspondence between each other data sequence except for this data sequence among all the data sequences and this data sequence, update this data sequence with the other data sequence. The determination subcomponent 1148 may be configured to, by averaging the updated data sequences, determine a reference data sequence of the geophysical parameter corresponding to the layer transition type.

According to an embodiment of this invention, the alignment subcomponent 1144 may be configured to determine data items having a correspondence therebetween of any two data sequences according to the Dynamic Time Warping algorithm.

According to an embodiment of this invention, the calculating subcomponent 1122 may comprise a calculating unit 1122-2 and a determining unit 1122-4. The calculating unit 1122-2 may be configured to calculate, for each adjusted reference data sequence obtained by adjusting a reference data sequence, inter-sequence distances at different depths underground between the adjusted reference data sequence and the data sequence of the geophysical parameter according to the Dynamic Time Warping algorithm, wherein each adjusted reference data sequence obtained by adjusting a reference data sequence is obtained by changing the number of data items included in the reference data sequence and the difference between the maximum data and minimum data of the reference data sequence, while keeping a data item at the middle position of the reference data sequence unchanged. The determining unit 1122-4 may be configured to determine results obtained by adjusting the inter-sequence distances according to the number of data items and the difference between the maximum value and the minimum value corresponding to the adjusted reference data sequence as the distances at different depths underground between the adjusted reference data sequence and the data sequence of the geophysical parameter.

According to an embodiment of this invention, the apparatus 1100 may further comprise a decision component 1150. The decision component 1150 may be configured to, by inputting at least one value of the multiple geophysical parameters at the middle position of a material layer between two adjacent depths underground into a decision tree model, determine whether the material layer is correct.

According to the embodiment of this invention, the apparatus 1100 may further comprises a deleting component 1160. The deleting component 1160 may be configured to, in response to determining that the material layer is incorrect, delete reference data sequences associated with a layer transition type indicating the material layer.

According to the embodiment of this invention, the apparatus 1100 may further comprises a sampling component 1170. The sampling component 1170 may be configured to perform multiple level sampling on each reference data sequence and the data sequence of each geophysical parameter in the well log. In this case, the matching component 1120 may be configured to match the reference data sequence subjected to the multiple level sampling with the data sequence subjected to the multiple level sampling at different depths underground.

The above various components, subcomponents and units may be realized by a processing unit, circuit modules implementing corresponding functions, or a combination thereof. Reference can be made to the description given with reference to FIGS. 2 to 9 for the above and other operations and/or functions of these components and subcomponents, which will not be repeated to avoid repetitions.

According to the novel apparatus for identifying subsurface material layers provided in an embodiment of this invention, with reference data sequences associated with transitional zones, based on a full consideration of variations of different geophysical parameters in a transitional zone of adjacent material layers, subsurface material layers may be identified more accurately. Further, data processing and analyzing on the well log and reference data sequences enable real-time identification of material layers according to the well log, and thus efficiency may be improved. Further, because multi-level sampling may be performed on the well log and the reference data sequences before their data processing and analyzing, the amount of data processing may be reduced, and thus data processing time and system cost may be reduced.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for identifying subsurface material layers, comprising:
acquiring, by one or more computer processors, a well log of a location to be explored, the well log comprising data sequences corresponding to multiple geophysical parameters, and a data sequence of each geophysical parameter comprising measurement values of the geophysical parameter at different depths underground;
matching, by one or more computer processors, a reference data sequence of each geophysical parameter corresponding to each of multiple layer transition types with the data sequence of that geophysical parameter in the well log at different depths underground, wherein each layer transition type indicates an upper material layer and an adjacent lower material layer, and the reference data sequence is used to represent a variation trend of the geophysical parameter in a transitional zone conforming with the layer transition type; and
according to the matching, determining, by one or more computer processors, a layer transition type present at the location to be explored and a depth underground of an interface between the upper material layer and the lower material layer indicated by the layer transition type.

2. The method according to claim 1, wherein matching a reference data sequence of each geophysical parameter corresponding to each of multiple layer transition types with the data sequence of that geophysical parameter in the well log at different depths underground comprises:
for each of the multiple geophysical parameters, calculating, by one or more computer processors, distances at different depths underground between adjusted reference data sequences and the data sequence of the geophysical parameter in the well log, wherein the adjusted reference data sequences are obtained by adjusting a number of data items included in the reference data sequence and a data amplitude of the reference data sequence of the geophysical parameter corresponding to each layer transition type; and
for each of the multiple layer transition types, summing, by one or more computer processors, distances at same depths underground calculated for geophysical parameters associated with the layer transition type, wherein, according to the matching, determining, by one or more computer processors, a layer transition type present at the location to be explored and a depth underground of an interface between the upper material layer and the lower material layer indicated by the layer transition type comprises:
according to a minimum value of the summed distances obtained for the multiple layer transition types, determining, by one or more computer processors, a layer transition type and a depth underground corresponding to the minimum value as a layer transition type present at the location to be explored and a depth underground of an interface between an upper material layer and a lower material layer indicated by the layer transition type, respectively.

3. The method according to claim 2, wherein the reference data sequence of each geophysical parameter corresponding to each layer transition type is predetermined based on multiple transitional zones having a predetermined thickness conforming with the layer transition type by the following steps:
acquiring, by one or more computer processors, data sequences characterizing the geophysical parameter associated with each transitional zone;
by aligning the data sequences characterizing the geophysical parameter associated with each transitional zone, determining, by one or more computer processors, a data correspondence between every two data sequences;
for each of the data sequences associated with the multiple transitional zones, according to a data correspondence between each other data sequence except for a first data sequence among the data sequences and the first data sequence, updating, by one or more computer processors, the first data sequence with the other data sequence; and
by averaging the updated data sequences, determining, by one or more computer processors, a reference data sequence of the geophysical parameter corresponding to the layer transition type.

4. The method according to claim 3, wherein determining a data correspondence between every two data sequences comprises:
determining, by one or more computer processors, data items having a correspondence therebetween any two data sequences according to a Dynamic Time Warping algorithm.

5. The method according to claim 2, wherein calculating distances at different depths underground between adjusted reference data sequences and the data sequence of the geophysical parameter in the well log comprises:
for each adjusted reference data sequence obtained by adjusting a reference data sequence, calculating, by one or more computer processors, inter-sequence distances at different depths underground between the adjusted reference data sequence and the data sequence of the geophysical parameter according to a Dynamic Time Warping algorithm, wherein each adjusted reference data sequence obtained by adjusting a reference data sequence is obtained by changing the number of data items included in the reference data sequence and a difference between a maximum data and a minimum data of the reference data sequence, while keeping a data item at a middle position of the reference data sequence unchanged; and
determining, by one or more computer processors, results obtained by adjusting the inter-sequence distances according to the number of data items and the difference between a maximum value and a minimum value corresponding to the adjusted reference data sequence as the distances at different depths underground between the adjusted reference data sequence and the data sequence of the geophysical parameter.

6. The method according to claim 1, wherein matching a reference data sequence of each geophysical parameter corresponding to each of multiple layer transition types with the data sequence of that geophysical parameter in the well log at different depths underground comprises:
for each of the multiple geophysical parameters, calculating, by one or more computer processors, distances at different depths underground between adjusted reference data sequences and the data sequence of the geophysical parameter in the well log, wherein the adjusted reference data sequences are obtained by adjusting a number of data items included in the reference data sequence and a data amplitude of the reference data sequence of the geophysical parameter corresponding to each layer transition type; and
for each of the multiple layer transition types, summing, by one or more computer processors, distances at same depths underground calculated for geophysical parameters associated with the layer transition type, wherein, according to the matching, determining, by one or more computer processors, a layer transition type present at the location to be explored and a depth underground of an interface between the upper material layer and the lower material layer indicated by the layer transition type comprises:
according to multiple values less than a predetermined threshold of the summed distances obtained for the multiple layer transition types, determining, by one or more computer processors, for each of the multiple values, a layer transition type and a depth underground corresponding to that value as a layer transition type present at the location to be explored and a depth underground of an interface between an upper material layer and a lower material layer indicated by the layer transition type.

7. The method according to claim 6, further comprising:
by inputting at least one value of the multiple geophysical parameters at a middle position of a material layer between two adjacent depths underground into a decision tree model, determining, by one or more computer processors, whether the material layer is correct.

8. The method according to claim 7, further comprising:
in response to determining that the material layer is incorrect, deleting, by one or more computer processors, reference data sequences associated with a layer transition type indicating the material layer.

9. The method according to claim 1, further comprising:
performing, by one or more computer processors, multiple level sampling on each reference data sequence and the data sequence of each geophysical parameter in the well log, wherein matching a reference data sequence of each geophysical parameter corresponding to each of multiple layer transition types with the data sequence of that geophysical parameter in the well log at different depths underground comprises:
matching, by one or more computer processors, the reference data sequence subjected to the multiple level sampling with the data sequence subjected to the multiple level sampling at different depths underground.

10. An apparatus for identifying subsurface material layers, comprising:
an acquisition component, configured to acquire a well log of a location to be explored, the well log comprising data sequences corresponding to multiple geophysical parameters, and a data sequence of each geophysical parameter comprising measurement values of the geophysical parameter at different depths underground;
a matching component, configured to match a reference data sequence of each geophysical parameter corresponding to each of multiple layer transition types with the data sequence of that geophysical parameter in the well log at different depths underground, wherein each layer transition type indicates an upper material layer and an adjacent lower material layer, and the reference data sequence is used to represent a variation trend of the geophysical parameter in a transitional zone conforming with the layer transition type; and
a determination component, configured to determine, according to the matching, a layer transition type present at the location to be explored and a depth underground of an interface between the upper material layer and the lower material layer indicated by the layer transition type.

11. The apparatus according to claim 10, wherein the matching component comprises:
a calculating subcomponent, configured to calculate, for each of the multiple geophysical parameters, distances at different depths underground between adjusted reference data sequences and the data sequence of the geophysical parameter in the well log, wherein the adjusted reference data sequences are obtained by adjusting a number of data items included in the reference data sequence and a data amplitude of the reference data sequence of the geophysical parameter corresponding to each layer transition type; and
a summing subcomponent, configured to sum, for each of the multiple layer transition types, distances at same depths underground calculated for geophysical parameters associated with the layer transition type, wherein the determination component is configured to determine, according to a minimum value of the summed distances obtained for the multiple layer transition types, a layer transition type and a depth underground corresponding to the minimum value as a layer transition type present at the location to be explored and a depth underground of an interface between an upper material layer and a lower material layer indicated by the layer transition type, respectively.

12. The apparatus according to claim 11, further comprising a reference data sequence determining component, configured to predetermine, based on multiple transitional zones having a predetermined thickness conforming with each layer transition type, the reference data sequence of each geophysical parameter corresponding to the layer transition type by the following subcomponents:
an acquisition subcomponent, configured to acquire data sequences characterizing the geophysical parameter associated with each transitional zone;
an alignment subcomponent, configured to, by aligning the data sequences characterizing the geophysical parameter associated with each transitional zone, determine a data correspondence between every two data sequences;
an updating subcomponent, configured to, for each of the data sequences associated with the multiple transitional zones, according to a data correspondence between each other data sequence except for a first data sequence among all the data sequences and the first data sequence, update the first data sequence with the other data sequence; and
a determination subcomponent, configured to, by averaging the updated data sequences, determine a reference data sequence of the geophysical parameter corresponding to the layer transition type.

13. The apparatus according to claim 12, wherein the alignment subcomponent is configured to determine data items having a correspondence therebetween any two data sequences according to a Dynamic Time Warping algorithm.

14. The apparatus according to claim 11, wherein the calculating subcomponent comprises:
a calculating unit, configured to calculate, for each adjusted reference data sequence obtained by adjusting a reference data sequence, inter-sequence distances at different depths underground between the adjusted reference data sequence and the data sequence of the geophysical parameter according to a Dynamic Time Warping algorithm, wherein each adjusted reference data sequence obtained by adjusting a reference data sequence is obtained by changing the number of data items included in the reference data sequence and a difference between a maximum data and a minimum data of the reference data sequence, while keeping a data item at a middle position of the reference data sequence unchanged; and
a determining unit, configured to determine results obtained by adjusting the inter-sequence distances according to the number of data items and the difference between a maximum value and a minimum value corresponding to the adjusted reference data sequence as the distances at different depths underground between the adjusted reference data sequence and the data sequence of the geophysical parameter.

15. The apparatus according to claim 10, wherein the matching component comprises:
a calculating subcomponent, configured to calculate, for each of the multiple geophysical parameters, distances at different depths underground between adjusted reference data sequences and the data sequence of the geophysical parameter in the well log, wherein the adjusted reference data sequences are obtained by adjusting a number of data items included in the reference data sequence and a data amplitude of the reference data sequence of the geophysical parameter corresponding to each layer transition type; and
a summing subcomponent, configured to sum, for each of the multiple layer transition types, distances at same depths underground calculated for geophysical parameters associated with the layer transition type, wherein, the determination component is configured to, according to multiple values less than a predetermined threshold of the summed distances obtained for the multiple layer transition types, determine, for each of the multiple values, a layer transition type and a depth underground corresponding to that value as a layer transition type present at the location to be explored and a depth underground of an interface between an upper material layer and a lower material layer indicated by the layer transition type.

16. The apparatus according to claim 15, further comprising:
a decision component, configured to, by inputting at least one value of the multiple geophysical parameters at a middle position of a material layer between two adjacent depths underground into a decision tree model, determine whether the material layer is correct.

17. The apparatus according to claim 16, further comprising:
a deleting component, configured to in response to determining that the material layer is incorrect, delete reference data sequences associated with a layer transition type indicating the material layer.

18. The apparatus according to claim 10, further comprising:
a sampling component, configured to perform multiple level sampling on each reference data sequence and the data sequence of each geophysical parameter in the well log, wherein the matching component is configured to match the reference data sequence subjected to the multiple level sampling with the data sequence subjected to the multiple level sampling at different depths underground.

19. A non-transitory computer program product for identifying subsurface material layers, comprising:
one or more computer readable storage media, and program instructions stored on the one or more computer readable storage media, the program instructions comprising:
program instructions to acquire a well log of a location to be explored, the well log comprising data sequences corresponding to multiple geophysical parameters, and a data sequence of each geophysical parameter comprising measurement values of the geophysical parameter at different depths underground;
program instructions to match a reference data sequence of each geophysical parameter corresponding to each of multiple layer transition types with the data sequence of that geophysical parameter in the well log at different depths underground, wherein each layer transition type indicates an upper material layer and an adjacent lower material layer, and the reference data sequence is used to represent a variation trend of the geophysical parameter in a transitional zone conforming with the layer transition type; and
according to the match, program instructions to determine a layer transition type present at the location to be explored and a depth underground of an interface between the upper material layer and the lower material layer indicated by the layer transition type.

20. The non-transitory computer program product according to claim 19, wherein the program instructions to match a reference data sequence of each geophysical parameter corresponding to each of multiple layer transition types with the data sequence of that geophysical parameter in the well log at different depths underground comprises:
for each of the multiple geophysical parameters, program instructions to calculate distances at different depths underground between adjusted reference data sequences and the data sequence of the geophysical parameter in the well log, wherein the adjusted reference data sequences are obtained by adjusting a number of data items included in the reference data sequence and a data amplitude of the reference data sequence of the geophysical parameter corresponding to each layer transition type; and
for each of the multiple layer transition types, program instructions to sum distances at same depths underground calculated for geophysical parameters associated with the layer transition type, wherein, according to the match, program instructions to determine a layer transition type present at the location to be explored and a depth underground of an interface between the upper material layer and the lower material layer indicated by the layer transition type comprises:
according to a minimum value of the summed distances obtained for the multiple layer transition types, program instructions to determine a layer transition type and a depth underground corresponding to the minimum value as a layer transition type present at the location to be explored and a depth underground of an interface between an upper material layer and a lower material layer indicated by the layer transition type, respectively.
